(19) United States
(12) Patent Application Publication
(10) Pub. No.: US 2016/0078477 A1
(43) Pub. Date: Mar. 17, 2016

(54) DISTRIBUTING CONTENT FOLLOWING CONVERSION

(71) Applicant: Google Inc., Mountain View, CA (US)

(72) Inventor: Alex Kwan Yeung Chik, New York, NY (US)

(21) Appl. No.: 14/486,787

(22) Filed: Sep. 15, 2014

(51) Int. Cl. G06Q 30/02; G06F 17/22; H04L 29/08

(52) U.S. Cl. CPC G06Q 30/0255; H04L 67/146; G06F 17/2247

(57) ABSTRACT

An example method includes: receiving data from a first computing device indicating that a visitor to a Web page has obtained a good or service; removing the visitor from a first audience segment corresponding to the good or service, where computing devices associated with members of the first audience segment store a first cookie, where the first cookie includes data indicating an interest in a good or service associated with the first audience segment; and instructing removal of the first cookie from a second computing device that the visitor used to visit the Web page, where the first cookie includes data stored on the second computing device indicating that the visitor has an interest in the good or service. The method also includes outputting a second cookie for storage on the second computing device. The second cookie includes data indicating that the visitor has obtained the good or service.

### TECHNICAL FIELD

This disclosure relates generally to distributing content, such as online advertising, following a conversion, such as a user purchase.

### BACKGROUND

The Internet provides access to a wide variety of resources. For example, content providers serve video, audio, and Web pages over the Internet. These resources present opportunities for other content (e.g., advertisements, or “ads”) to be provided along with the resources. For example, a Web page can include slots in which ads can be presented. The slots can be allocated to other content providers (e.g., advertisers) for the presentation of content.

### SUMMARY

An example method includes: receiving data from a first computing device indicating that a visitor to a Web page has obtained a good or service; removing the visitor from a first audience segment corresponding to the good or service, where the visitor is removed in response to receipt of the data, where computing devices associated with members of the first audience segment store a first cookie, and where the first cookie includes data indicating an interest in a good or service associated with the first audience segment; and instructing removal of the first cookie from a second computing device that the visitor used to visit the Web page, where the first cookie includes data stored on the second computing device indicating that the visitor has an interest in the good or service. The example method also includes outputting a second cookie for storage on the second computing device, where the second cookie includes data indicating that the visitor has obtained the good or service, and where the second cookie is readable by Web pages promoting the good or service to inform the Web pages that the visitor has already obtained the good or service. The example method may include one or more of the following features, either alone or in combination.

The second cookie may be configured to expire after a period of time following storage on the second computing device. Following expiration of the second cookie, the method may include: receiving data from a third computing device indicating that a visitor to a Web page is interested in the good or service; and storing the first cookie on the second computing device.

The example method may include: assigning the visitor to a second audience segment, where computing devices associated with members of the second audience segment store a third cookie, and where the third cookie includes data indicating an interest that has a relationship to the good or service but that is not an interest in purchasing the good or service; and storing the third cookie on the second computing device. The third cookie may be configured to expire after a period of time following storage on the second computing device. Following expiration of the third cookie, the method may include: receiving data from a third computing device indicating that a visitor to a Web page is interested in the good or service; and outputting the first cookie for storage on the second computing device.

The first computing device may host the Web page or at least part of a Web site containing the Web page; and the one or more processing devices, the first computing device, and the second computing device may be at different geographic locations.

The example method may include: assigning the visitor to additional audience segments, where computing devices associated with members of the additional audience segments store additional cookies, and where the additional cookies include data indicating interests that have a relationship to the good or service but that is not an interest in purchasing the good or service; and storing the additional cookies on the second computing device. The second cookie may be stored in a Web browser on the second computing device, with the Web browser having been used to visit the Web page.

Features described in this disclosure/specification, including this summary section, can be combined to form implementations not specifically described herein.

The systems and techniques described herein, or portions thereof, can be implemented as a computer program product that includes instructions that are stored on one or more non-transitory machine-readable storage media, and that are executable on one or more processing devices. The systems and techniques described herein, or portions thereof, can be implemented as an apparatus, method, or electronic system that can include one or more processing devices and memory to store executable instructions to implement the stated operations.

The details of one or more implementations are set forth in the accompanying drawings and the description below. Other features, objects, and advantages will be apparent from the description and drawings, and from the claims.

### DESCRIPTION OF THE DRAWINGS

FIG. 1 is a block diagram of an example network environment on which the example processes described herein can be implemented.

FIG. 2 is flowchart showing an example of a process for providing information about content distribution.

FIG. 3 is a block diagram of a computer system on which the example processes described herein may be performed.

Like reference symbols in the various drawings indicate like elements.

### DETAILED DESCRIPTION

The example systems and processes herein are initially described in the context of online advertising (referred to as an “ad” or “ads”); however, the systems and processes described herein are applicable for use with any appropriate type of online content in any appropriate type of distribution process.

Content, such as advertising, may be provided to network users based, e.g., on demographics, keywords, language, and interests. For example, in response to a user visiting a Web site, with appropriate user permission, a data management platform (DMP) may infer interests of the user and classify the user into one or more audience segments. In some examples, an audience segment may include a class of people who the DMP has classified as having an interest in a certain type of subject matter. For example, an audience segment may be located, geographically, in Boston, and the subject matter may be sports. A user may be classified into any appropriate number of audience segments, depending upon the activities of the user at the Web site and any other available knowledge of the user.

In some implementations, upon classifying the user into an audience segment, with appropriate user permission, the DMP stores a cookie on a Web browser of the user's computing device (e.g., laptop, destkop, tablet, smartphone, etc.). The cookie includes data indicating that the user has an interest in a particular subject. The cookie (and thus inference of interest in the subject matter) is set based on the user's membership in an audience segment.

The cookie remains on the user's browser for some period of time before the cookie expires. During that period of time, the user visits a Web site that subscribes to services provided by the DMP. In some implementations, only Web site subscribers to the DMP are able to read the contents of the cookie stored in the user's Web browser by the DMP. The visited Web site reads the cookie in the user's browser, and determines the user's interest in the subject matter of the cookie. For example, if the cookie indicates that the user is interested in sports, the Web site determines that the user is interested in sports based on data in the cookie.

Based on this knowledge, the Web site is able to determine content to distribute to the user in which the user might have interest. For example, if the cookie indicates that the user is a sports fan, the Web site may distribute content to the user about sports. In an example implementation, the content may include online advertising. So, if the Web site knows that the user is interested in sports, the Web site may distribute advertising relating to upcoming games, sports memorabilia, and so forth. The content may be distributed in an appropriate location on the Web site, such as slots on a Web page that are reserved for advertising.

In some implementations, a content management system, which serves ads, may receive a request from the Web site for content (e.g., ads) relating to the specific subject matter in which the user has an interest. For example, the request may include one or more keywords relating to the subject matter (e.g., sports), geographic information, demographic information, and so forth. The content management system may provide appropriate content to the Web site which, in turn, incorporates that content (e.g., an ad) into appropriate slots, and output the content to the user, along with the remainder of the Web site content. The content and the ad are displayed on a computing device. When displayed, the ad is incorporated into an appropriate slot on a search results page in this example. The user may select the ad by clicking-on the ad. In response, a hyperlink associated with the ad directs the user to another Web page. For example, if the ad is for ABC Travel Company, the Web page to which the user is directed may be the home page for ABC Travel Company. This type of content access is known as click-through. In this context, a “click” is not limited to a mouse click, but rather may include a touch, a programmatic selection, or any other interaction by which the ad may be selected.

A content auction may be run to determine which content is to be output in response to receipt of keywords or other parameters. In the auction, content providers may bid on specific keywords (which are associated with content). For example, a sporting goods ads provider may associate words such as “baseball”, “football” and “basketball” with their ads. The content provider may bid on those keywords in the content auction, typically on a cost-per-click (CPC) basis.

The content provider's bid is an amount (e.g., a maximum amount) that the content provider will pay in response to users clicking on their displayed content. So, for example, if a content provider bids five cents per click, then the content provider may pay five cents each time their content is clicked-on by a user, depending upon the type of the auction. In other examples, payment need not be on a cost-per-click (CPC) basis, but rather may be on the basis of other actions (e.g., an amount of time spent on a landing page, a purchase, and so forth).

Bidding in a content auction typically takes place against other content providers bidding for, e.g., the same keywords. So, for example, if a user has an interest in specific content, a content management system may select content items from different content providers that relate to that interest. The content auction is then run (e.g., by the content management system) to determine which content (e.g., which ads) to serve along with any other requested content. The winner may be decided, e.g., based on bidding price, relevance of the keywords identifying the interest to content, and other factors. In this context, a page includes any display area, such as a Web page, a continuously scrollable screen, and so forth. In some implementations, winners of the content auction will be accorded the most preferred slot(s) on the page, while others will be accorded slots that are less preferred.

In the above example, the cookie from the DMP remains in the user's browser for a period of time. Regardless of whether the user's interest change within that period, the cookie will still register, to a subscribing Web site, that the user has an interest in the subject matter of the cookie. For example, if the cookie indicates that the user has an interest in a particular type of sneaker, the cookie will continue to indicate to Web sites that the user has an interest in that sneaker even after the user has obtained (e.g., purchased or otherwise acquired) that sneaker. Presumably, following purchase, the user no longer needs to see content (e.g., ads) relating to the sneaker; however, the presence of the cookie results in continued distribution of content (e.g., ads) to the user regarding the sneaker.

Accordingly, in the example implementations described herein, in response to a conversion or other appropriate action on a Web site, that Web site provides appropriate notice to the DMP. In the above sneaker example, if the user has purchased the sneaker from a Web site, that Web site (with appropriate user permission) will advise the DMP of the purchase. The DMP will then remove the user from the corresponding audience segment, and remove the cookie from the user's browser that indicates that the user has an interest in that subject matter (e.g., the sneaker). In some implementations, the DMP may store another, different cookie on the user's browser indicating that the user has made a conversion (e.g., purchased the sneaker). This additional cookie is readable by subsequently-visited Web sites. As a result, those Web sites will know not to send information to the DMP to place the user into an audience segment corresponding to the subject matter (which would cause the DMP to store another cookie on the user's browser).

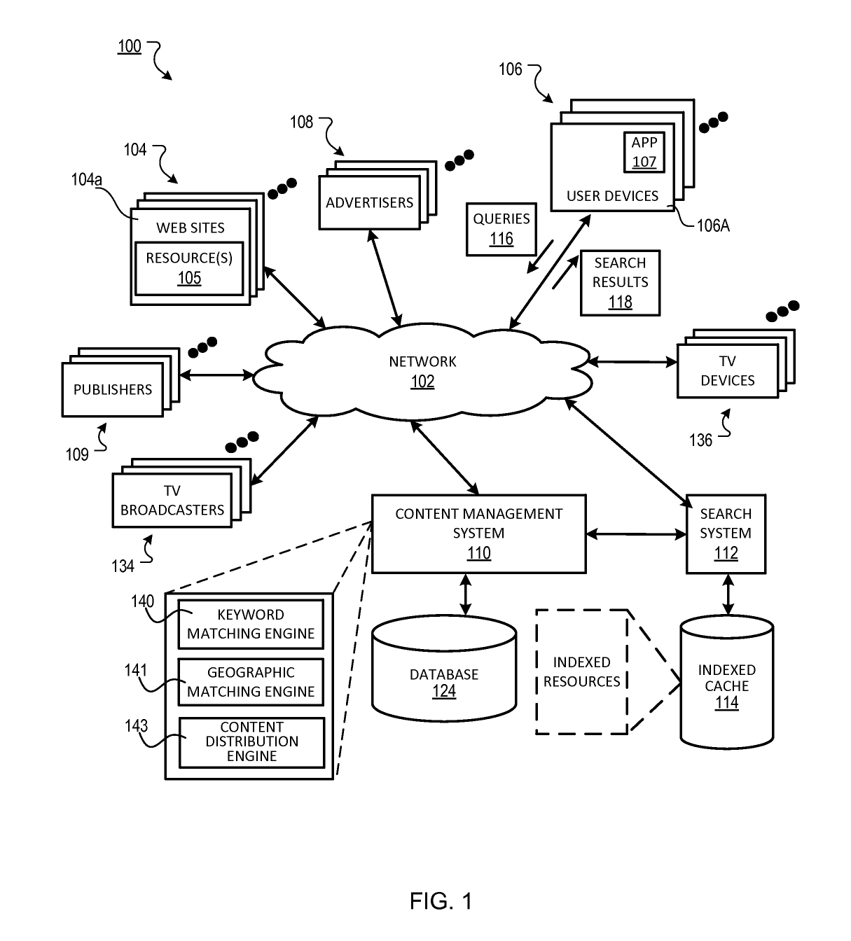

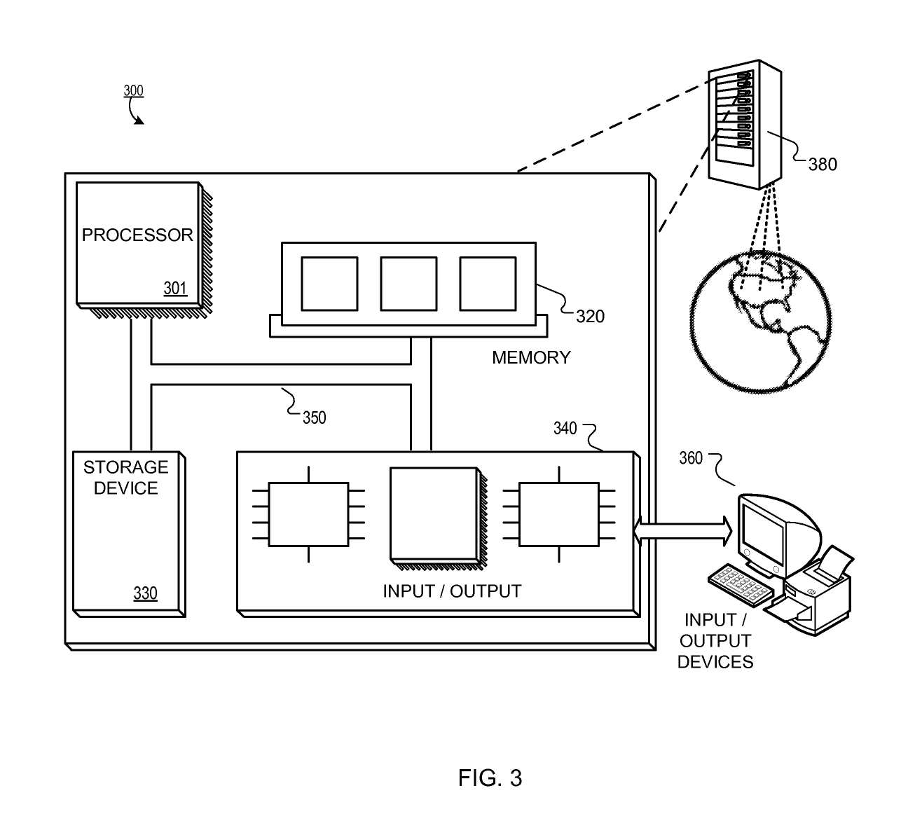

FIG. 1 is a block diagram of an example environment 100 on which the example processes described herein may be implemented. Any of the entities of FIG. 1 may be implemented, for example, using one or more servers or processing devices, such as those described with respect to FIG. 3. The designations given to these entities are for illustrative purposes and are non-limiting.

Network 102 can represent a communications network that can allow devices, such as a user device 106a, to communicate with entities on the network through a communication interface (not shown), which can include digital signal processing circuitry. Network 102 can include one or more networks. The network(s) can provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, General Packet Radio System (GPRS), or one or more television or cable networks, among others. For example, the communication can occur through a radio-frequency transceiver. In addition, short-range communication can occur, such as using a Bluetooth®, WiFi®, or other such transceiver.

Network 102 connects various entities, such as Web sites 104, user devices 106, content providers (e.g., advertisers 108), online publishers 109, and a content management system 110. In this regard, example environment 100 can include many thousands of Web sites 104, user devices 106, and content providers (e.g., advertisers 108). Entities connected to network 102 include and/or connect through one or more servers. Each such server can be one or more of various forms of servers, such as a Web server, an application server, a proxy server, a network server, or a server farm. Each server can include one or more processing devices, memory, and a storage system.

Web sites 104 can include one or more resources 105 hosted by one or more servers. An example Web site 104a is a collection of Web pages formatted in hypertext markup language (HTML) that can contain text, images, multimedia content, and programming elements, such as scripts. Each Web site 104 can be maintained by a publisher 109, which may be an entity that controls, manages and/or owns the Web site 104 (on which advertising may be presented). In some implementations, the DMP may be hosted by one or more of the servers that host Web sites 104 (and may be part of the resources provided by Web sites 104). In some implementations, the DMP may be part of the content management system. In some implementations, the DMP may be distributed among various hardware elements shown in the network of FIG. 1

A resource 105 can be any appropriate data that can be provided over network 102. A resource 105 can be identified by a resource address that is associated with the resource 105. Resources 105 can include HTML pages, word processing documents, portable document format (PDF) documents, images, video, and news feed sources, to name a few. Resources 105 can include, but are not limited to, content, such as words, phrases, images and sounds, that can include embedded information (such as meta-information hyperlinks) and/or embedded instructions (such as JavaScript® scripts). Examples of resources also include information about keywords, online video, electronic commerce, or any other subject for which a graphic is generated.

To facilitate searching of resources 105, environment 100 can include a search system 112 (including a search engine) that identifies resources 105 by crawling and indexing the resources 105. Data about resources 105 can be indexed based on the resource to which the data corresponds. The indexed and, optionally, cached copies of resources 105 can be stored in an indexed cache 114.

An example user device 106a is an electronic device that is under control of a user and that is capable of requesting and receiving resources over the network 102. A user device can include one or more processing devices, and can be, or include, a mobile telephone (e.g., a smartphone), a laptop computer, a handheld computer, an interactive or so-called “smart” television or set-top box, a tablet computer, a network appliance, a camera, an enhanced general packet radio service (EGPRS) mobile phone, a media player, a navigation device, an email device, a game console, or a combination of any two or more of these data processing devices or other data processing devices. In some implementations, the user device can be included as part of a motor vehicle.

User device 106a may include/store one or more user applications, such as a Web browser, to facilitate the sending and receiving of data over network 102. A user device 106a that is mobile (or simply, “mobile device”), such as a smartphone or a table computer, can include an application (“app”) 107 that allows the user to conduct a network (e.g., Web) search.

User device 106a can request resources 105 from a Web site 104a. In turn, data representing resource 105 can be provided to the user device 106a for presentation by the user device 106a. User devices 106 can also submit search queries 116 to the search system 112 over the network 102. A request for a resource 105 or a search query 116 sent from a user device 106 can include an identifier, such as a cookie, identifying the user of the user device.

In response to a search query 116 or identified user interest, the search system 112 can access the indexed cache 114 to identify resources 105 that are relevant to the search query 116 (e.g., information about keywords). The search system 112 identifies the resources 105 in the form of search results 118 and returns the search results 118 to a user device 106 in search results pages. A search result 118 can include data generated by the search system 112 that identifies a resource 105 that is responsive to a particular search query 116.

Content management system 110 can be used for selecting and providing content (e.g., ads, video, and so forth) in response to requests for content. Content management system 110 also can, with appropriate user permission, update database 124 based on activity of a user. The user may enable and/or disable the storing of such information. With appropriate user permission obtained beforehand, database 124 can store a profile for the user. In some implementations, the information in database 124 can be derived, for example, from one or more of a query log, an advertisement log, or requests for content.

Content management system 110 may include a keyword matching engine 140 to compare query keywords to content keywords and to generate a keyword matching score indicative of how well the query keywords match the content keywords. In an example, the keyword matching score is equal, or proportional, to a sum of a number of matches of words in the input query to words associated with the content. Content management system 110 may include a geographic (or “geo-”) matching engine 141 to compare geographic information (e.g., numerical values for place names) obtained from words in input queries to geographic information associated with content. Content management system 110 may also include other engines (not shown) for matching input demographics to desired demographics of an advertising campaign, for identifying Web pages or other distribution mechanisms based on content, and so forth.

When a resource 105 or search results 118 are requested by a user device 106, content management system 110 can receive a request for content to be provided with resource 105 or search results 118. The request for content can include characteristics of one or more “slots” that are defined for the requested resource 105 or search results page. For example, data representing resource 105 can include data specifying a portion of resource 105 or a portion of a user display, such as a presentation location of a pop-up window or a slot of a third-party content site or Web page, in which content can be presented. An example slot is an ad slot. Search results pages can also include one or more slots in which other content items (e.g., ads) can be presented.

Information about slots can be provided to content management system 110. For example, a reference (e.g., URL) to the resource for which the slot is defined, a size of the slot, and/or media types that are available for presentation in the slot can be provided to the content management system 110. Similarly, keywords associated with a requested resource or a search query 116 for which search results are requested can also be provided to the content management system 110 to facilitate identification of content that is relevant to the resource or search query 116.

Based at least in part on data generated from and/or included in the request, content management system 110 can select content that is eligible to be provided in response to the request (“eligible content items”). For example, eligible content items can include eligible ads having characteristics matching keywords, understood intents to perform an online activity, geographic information, demographic information, known interests, etc. associated with corresponding content. In some implementations, the universe of eligible content items (e.g., ads) can be narrowed by taking into account other factors, such as previous search queries 116. For example, content items corresponding to historical search activities of the user (obtained with appropriate prior permission of the user) including, e.g., search keywords used, particular content interacted with, sites visited by the user, etc. can also be used in the selection of eligible content items by the content management system 110.

Content management system 110 can select the eligible content items that are to be provided for presentation in slots of a resource 105 or search results page 118 based, at least in part, on results of an auction, such as a second price auction. For example, for eligible content items, content management system 110 can receive bids from content providers (e.g., advertisers 108) and allocate slots, based at least in part on the received bids (e.g., based on the highest bidders at the conclusion of the auction). The bids are amounts that the content providers are willing to pay for presentation (or selection) of their content with a resource 105 or search results page 118. For example, a bid for keywords can specify an amount that a content provider is willing to pay for each 2000 impressions (e.g., presentations) of the content item, referred to as a CPM bid. Alternatively, the bid for keywords can specify an amount that the content provider is willing to pay for a selection (e.g., a click-through) of the content item or a conversion following selection of the content item. This is referred to as cost-per-click (CPC). The selected content item can be determined based on the bids alone, or based on the bids of each bidder being multiplied by one or more factors, such as quality scores derived from content performance, landing page scores, and/or other factors.

In some implementations, TV (Television) broadcasters 134 produce and present television content on TV user devices 136, where the television content can be organized into one or more channels. TV broadcasters 134 can include, along with the television content, one or more content slots in which other content (e.g., advertisements) can be presented. For example, a TV network can sell slots of advertising to advertisers in television programs that they broadcast. Some or all of the content slots can be described in terms of user audiences which represent typical users who watch content with which a respective content slot is associated. Content providers can bid, in an auction (as described above), on a content slot that is associated with keywords for particular television content.

Content selected for output may be distributed by content distribution engine 143, which is also part of the content management system. Example process 200 below may be performed by a DMP in conjunction with the content management system described above. For example, the DMP may include one or more processing devices (e.g., servers) to implement example process 200.

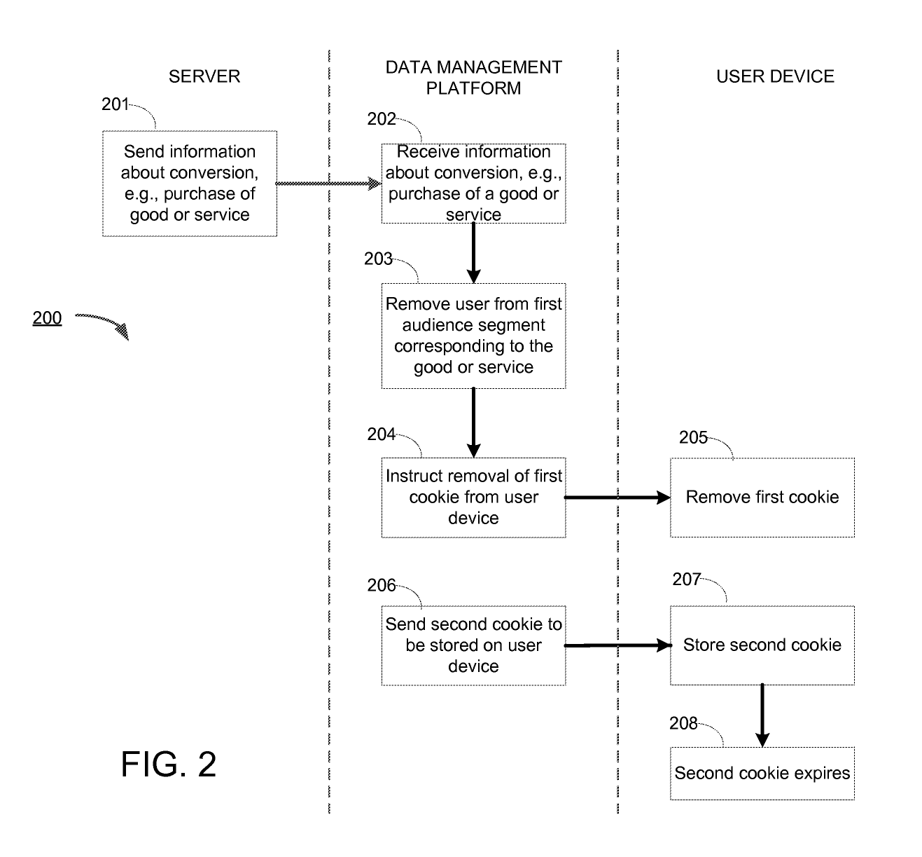

FIG. 2 is a flowchart showing an example of a process 200 for distributing content, such as online advertising, following a conversion, such as a user purchase. Process 200 may be executed in response, e.g., to a user's interaction with a Web site. For example, a user may purchase a product, fill-out a form, join a group, input a comment, endorse content, and so forth. Such activities, and others like them, may be characterized as conversions, since they constitute activities that result from interaction with online content. The following describes example process 200 for an online purchase (a type of conversion). However, example process 200 is not limited to use with online purchases, and may be used with any appropriate type of conversion.

According to example process 200, a user makes an online purchase of a good or service from a Web site. The Web site is hosted by one or more servers. Accordingly, FIG. 2 shows the “SERVER” acting on behalf of the Web site. In this example, information about the conversion is sent (201) from the server to a DMP, which is described below. The information may be sent with appropriate user permission, and may include, but is not limited to, the identity of the user or the user's computing device, the identity of the Web site visited and when that Web site was visited, the type of conversion that occurred (in this example, purchase of a good or service through the Web site), the identity of the product purchased, the price of the purchase, frequency of user visits to the Web site, and so forth. The user may decline to grant permission for this information to be sent, in which case the process would not proceed. In the following description, the user has granted permission for such information to be sent to the DMP.

In some implementations, the DMP is a service, which is implemented by one or more computer programs executing one or more servers, to identify user interests based, e.g., on conversion information, and to enable third parties to leverage those interests in order to distribute content in a way that is beneficial to users. For example, in some implementations, the DMP maintains interest groups, called “audience segments”. In some implementations, an audience segment is a group of users having one or more interests or other features (e.g., demographics) in common. The interests or other features may be parsed to any appropriate degree of granularity. For example, an audience segment may include a class of people who the DMP has classified as having an interest in a certain type of subject matter. For example, an audience segment may be located, geographically, in Boston, and the subject matter may be sports. In another example, the subject matter may be baseball or a particular sport's team. With appropriate permission from the user, the DMP may classify the user into any appropriate number of audience segments, based upon their online activities and any other available information about the user.

Information about the conversion is received (202) at the DMP. With appropriate user permission, the DMP uses the conversion information to infer interests of the user, and to classify the users into one or appropriate more audience segments. Third party sources, such as Web sites, may have access to this information, and may use this information in distributing content of interest to the user, as described below.

In some implementations, upon classifying the user into an audience segment, with appropriate user permission, the DMP stores data, e.g., a cookie, on the Web browser of the user's computing device (e.g., laptop, desktop, tablet, smartphone, etc.). The cookie, which may remain on user's computing device until its expiration, includes data indicating that the user has an interest in a particular subject matter. The cookie may be set based on the user's membership in a DMP audience segment. In some implementations, when the user visits a Web site that subscribes to the DMP service, with appropriate user permission, the visited Web site reads the cookie in the user's Web browser and determine that the user is interested in subject matter identified by the cookie (e.g., Boston sports teams). The Web site may send a request to the content management system, which may distribute content (e.g., online advertising) relating to the subject matter in which the user has an interest. For example, the request may include one or more keywords relating to the subject matter, geographic information, demographic information, and so forth. The content management system may run a content auction, as described above, and provide appropriate content to the Web site which, in turn, incorporates that content (e.g., ad content) into appropriate slots, and outputs the content to the user, along with the remainder of the Web site content. The Web site content and the ad content may then displayed on the user's computing device.

In some implementations, the cookie set by the DMP can be read by Web sites that subscribe to the DMP service, and that cookie remains in the user's browser for a period of time. For example, the cookie may expire after six months. In some examples, if a user does not engage in any activities related to the subject matter of the cookie (e.g., sports) online, the cookie will expire, no new cookie will be stored, and content related to the subject matter not be distributed to the user via the DMP. In this regard, so long as the cookie remains valid, it will continue to register, to subscribing Web sites, that the user has an interest in the subject matter of the cookie. For example, if the cookie indicates that the user has an interest in a particular type of sneaker, the cookie will continue to indicate to Web sites that the user has an interest in that sneaker, even after the user has purchased that sneaker. Following purchase, however, the user may no longer wish to see content (e.g., ads) relating to the subject matter, e.g., the sneaker.

Therefore, according to process 200, in response to receipt of information about the conversion (e.g., an online purchase), the user is removed (203) from the audience segment corresponding to the subject matter of the purchase (e.g., the good or service purchased). In the example above, after the user makes a purchase of the sneaker, the DMP removes the user from the audience segment of users interested in the sneaker. The DMP also instructs (204) removal of the cookie from the user's computing device. For example, the DMP or the user's computing device may delete the cookie from the user's computing device or cause the cookie to be deleted. Removing the cookie from the user's computing device (205) effectively dissociates the user from the audience segment of people interested in the subject matter (e.g., the sneaker) identified by the cookie. For example, since the user's computing device no longer contains the DMP cookie relating to that subject matter, Web sites that the user visits will no longer identify the user as someone having an interest in the subject matter associated with the cookie and, as a result, will not distribute content (e.g., online adverting) relating to that subject matter to the user.

According to process 200, additional data is sent by the DMP for storage on the user's computing device. For example, in some implementations, another (e.g., a second, different) cookie is sent by the DMP for storage in the Web browser (206) of the user's computing device. The user's computing device receives and stores the second cookie in its Web browser (207). This cookie includes data indicating that the user has made a conversion (e.g., purchased a good or service, such as a sneaker). So long as this second cookie remains valid and on the user's computing device, the cookie can be read by Web sites that subscribe to the DMP service. Accordingly, because of this the cookie, the Web sites, in turn, know not to send information to the DMP to place the user into an audience segment corresponding to the previously-purchased subject matter (which would cause the DMP again to store the initial cookie on the user's Web browser).

According to process 200, the second cookie is configured to expire (208) after a period of time following storage on the user's computing device. Following expiration of the second cookie, the DMP may again associate the user with an audience segment relating to the purchased good or service.

In some implementations, the DMP may associate the user with another audience segment that has a relationship to the good or service that was previously purchased. For example, the DMP may associate a user who purchased sneakers to an audience segment having in interest in that sneaker's manufacturer, or to an audience segment having an interest athletic socks that pair with the sneaker. The DMP may, with appropriate user permission, store additional data on the user's computing device indicating that interest. For example, the DMP may store another cookie, which includes data indicating the interest. Web sites that subscribe to the DMP's service may read the data from the cookie, and identify the user as having an interest in a particular subject matter. The Web sites may distribute content to the user, which the user may have an interest in, in the manner described above (e.g., through the content management system).

In some implementations, the above-described cookie is configured to expire after a period of time following storage in the Web browser on the second computing device. Following expiration of cookie, as was the case above, Web sites that subscribe to the DMP's service, will not have access to data from the cookie indicating user interest in a particular subject matter.

In some implementations, the server hosts the Web page or at least part of the Web site containing the Web page. The various computing devices may be at different geographic locations. For example, the DMP, the Web server, and the user's computer may be located in different cities, states, countries, and so forth.

The processes described herein are not limited to use in the example contexts described above, but rather may be used in any appropriate context to display content in response to any appropriate type of conversion.

FIG. 3 is block diagram of an example computer system 300 that may be used in performing the processes described herein (e.g., processes 200 and 600). System 300 includes a processor 310, a memory 320, a storage device 330, and an input/output device 340. Each of components 310, 320, 330, and 340 can be interconnected, for example, using a system bus 350. The processor 310 is capable of processing instructions for execution within the system 300. In one implementation, processor 310 is a single-threaded processor. In another implementation, the processor 310 is a multi-threaded processor. The processor 310 is capable of processing instructions stored in the memory 320 or on the storage device 330.

The memory 320 stores information within the system 300. In one implementation, the memory 320 is a computer-readable medium. In one implementation, the memory 320 is a volatile memory unit. In another implementation, the memory 320 is a non-volatile memory unit.

The storage device 330 is capable of providing mass storage for the system 300. In one implementation, the storage device 330 is a computer-readable medium. In various different implementations, the storage device 330 can include, for example, a hard disk device, an optical disk device, or some other large capacity storage device.

The input/output device 340 provides input/output operations for the system 300. In one implementation, the input/output device 340 can include one or more of a network interface devices, e.g., an Ethernet card, a serial communication device, e.g., an RS-232 port, and/or a wireless interface device, e.g., and 802.11 card. In another implementation, the input/output device can include driver devices configured to receive input data and send output data to other input/output devices, e.g., keyboard, printer and display devices 360.

The web server, advertisement server, and impression allocation module can be realized by instructions that upon execution cause one or more processing devices to carry out the processes and functions described above. Such instructions can comprise, for example, interpreted instructions, such as script instructions, e.g., JavaScript® or ECMAScript instructions, or executable code, or other instructions stored in a computer readable medium. The web server and advertisement server can be distributively implemented over a network, such as a server farm, or can be implemented in a single computer device.

Example computer system 300 is depicted as a rack in a server 380 in this example. As shown the server may include multiple such racks. Various servers, which may act in concert to perform the processes described herein, may be at different geographic locations, as shown in the figure. The processes described herein may be implemented on such a server or on multiple such servers. As shown, the servers may be provided at a single location or located at various places throughout the globe. The servers may coordinate their operation in order to provide the capabilities to implement the processes.

Although an example processing system has been described in FIG. 3, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

In this regard, various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Content, such as ads and GUIs, generated according to the processes described herein may be displayed on a computer peripheral (e.g., a monitor) associated with a computer. The display physically transforms the computer peripheral. For example, if the computer peripheral is an LCD display, the orientations of liquid crystals are changed by the application of biasing voltages in a physical transformation that is visually apparent to the user. As another example, if the computer peripheral is a cathode ray tube (CRT), the state of a fluorescent screen is changed by the impact of electrons in a physical transformation that is also visually apparent. Moreover, the display of content on a computer peripheral is tied to a particular machine, namely, the computer peripheral.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether and/or how to receive content from the content server that may be more relevant to the user. In addition, certain data may be anonymized in one or more ways before it is stored or used, so that personally identifiable information is removed when generating monetizable parameters (e.g., monetizable demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

Elements of different implementations described herein can be combined to form other implementations not specifically set forth above. Elements can be left out of the processes, computer programs, etc. described herein without adversely affecting their operation. In addition, the logic flows depicted in the figures do not require the particular order shown, or sequential order, to achieve desirable results. Various separate elements can be combined into one or more individual elements to perform the functions described herein.

Other implementations not specifically described herein are also within the scope of the following claims.

What is claimed is:

1. A method comprising:
receiving, by one or more processing devices, data from a first computing device indicating that a visitor to a Web page has obtained a good or service;
removing, by the one or more processing devices, the visitor from a first audience segment corresponding to the good or service, the visitor being removed in response to receipt of the data, wherein computing devices associated with members of the first audience segment store a first cookie, the first cookie comprising data indicating an interest in a good or service associated with the first audience segment;
instructing, by the one or more processing devices, removal of the first cookie from a second computing device that the visitor used to visit the Web page, the first cookie comprising data stored on the second computing device indicating that the visitor has an interest in the good or service; and
outputting, by the one or more processing devices, a second cookie for storage on the second computing device, the second cookie comprising data indicating that the visitor has obtained the good or service, the second cookie being readable by Web pages promoting the good or service to inform the Web pages that the visitor has already obtained the good or service.

2. The method of claim 1, wherein the second cookie is configured to expire after a period of time following storage on the second computing device;
wherein, following expiration of the second cookie, the method comprises:
receiving, by the one or more processing devices, data from a third computing device indicating that a visitor to a Web page is interested in the good or service; and
storing, by the one or more processing devices, the first cookie on the second computing device.

3. The method of claim 1, further comprising:
assigning, by the one or more processing devices, the visitor to a second audience segment, wherein computing devices associated with members of the second audience segment store a third cookie, the third cookie comprising data indicating an interest that has a relationship to the good or service but that is not an interest in purchasing the good or service; and
storing, by the one or more processing devices, the third cookie on the second computing device.

4. The method of claim 3, wherein the third cookie is configured to expire after a period of time following storage on the second computing device;
wherein, following expiration of the third cookie, the method comprises:
receiving, by the one or more processing devices, data from a third computing device indicating that a visitor to a Web page is interested in the good or service; and
outputting, by the one or more processing devices, the first cookie for storage on the second computing device.

5. The method of claim 1, wherein the first computing device hosts the Web page or at least part of a Web site containing the Web page; and
wherein the one or more processing devices, the first computing device, and the second computing device are at different geographic locations.

6. The method of claim 1, further comprising:
assigning, by the one or more processing devices, the visitor to additional audience segments, wherein computing devices associated with members of the additional audience segments store additional cookies, the additional cookies comprising data indicating interests that have a relationship to the good or service but that is not an interest in purchasing the good or service; and
storing, by the one or more processing devices, the additional cookies on the second computing device.

7. The method of claim 1, wherein the second cookie is stored in a Web browser on the second computing device, the Web browser having been used to visit the Web page.

8. A system comprising:
memory storing instructions that are executable; and
one or more processing devices to execute the instructions to perform operations comprising:
receiving, by the one or more processing devices, data from a first computing device indicating that a visitor to a Web page has obtained a good or service;
removing, by the one or more processing devices, the visitor from a first audience segment corresponding to the good or service, the visitor being removed in response to receipt of the data, wherein computing devices associated with members of the first audience segment store a first cookie, the first cookie comprising data indicating an interest in a good or service associated with the first audience segment;
instructing, by the one or more processing devices, removal of the first cookie from a second computing device that the visitor used to visit the Web page, the first cookie comprising data stored on the second computing device indicating that the visitor has an interest in the good or service; and
outputting, by the one or more processing devices, a second cookie for storage on the second computing device, the second cookie comprising data indicating that the visitor has obtained the good or service, the second cookie being readable by Web pages promoting the good or service to inform the Web pages that the visitor has already obtained the good or service.

9. The system of claim 8, wherein the second cookie is configured to expire after a period of time following storage on the second computing device;
wherein, following expiration of the second cookie, the operations comprise:
receiving, by the one or more processing devices, data from a third computing device indicating that a visitor to a Web page is interested in the good or service; and
storing, by the one or more processing devices, the first cookie on the second computing device.

10. The system of claim 8, wherein the operations comprise:
assigning, by the one or more processing devices, the visitor to a second audience segment, wherein computing devices associated with members of the second audience segment store a third cookie, the third cookie comprising data indicating an interest that has a relationship to the good or service but that is not an interest in purchasing the good or service; and
storing, by the one or more processing devices, the third cookie on the second computing device.

11. The system of claim 10, wherein the third cookie is configured to expire after a period of time following storage on the second computing device;
wherein, following expiration of the third cookie, the operations comprise:
receiving, by the one or more processing devices, data from a third computing device indicating that a visitor to a Web page is interested in the good or service; and
outputting, by the one or more processing devices, the first cookie for storage on the second computing device.

12. The system of claim 8, wherein the first computing device hosts the Web page or at least part of a Web site containing the Web page; and
wherein the system, the first computing device, and the second computing device are at different geographic locations.

13. The system of claim 8, wherein the operations comprise:
assigning, by the one or more processing devices, the visitor to additional audience segments, wherein computing devices associated with members of the additional audience segments store additional cookies, the additional cookies comprising data indicating interests that have a relationship to the good or service but that is not an interest in purchasing the good or service; and
storing, by the one or more processing devices, the additional cookies on the second computing device.

14. The system of claim 8, wherein the second cookie is stored in a Web browser on the second computing device, the Web browser having been used to visit the Web page.

15. One or more non-transitory machine-readable storage media storing instructions that are executable by one or more processing devices to perform operations comprising:
receiving data from a first computing device indicating that a visitor to a Web page has obtained a good or service;
removing the visitor from a first audience segment corresponding to the good or service, the visitor being removed in response to receipt of the data, wherein computing devices associated with members of the first audience segment store a first cookie, the first cookie comprising data indicating an interest in a good or service associated with the first audience segment;
instructing removal of the first cookie from a second computing device that the visitor used to visit the Web page, the first cookie comprising data stored on the second computing device indicating that the visitor has an interest in the good or service; and
outputting a second cookie for storage on the second computing device, the second cookie comprising data indicating that the visitor has obtained the good or service, the second cookie being readable by Web pages promoting the good or service to inform the Web pages that the visitor has already obtained the good or service.

16. The one or more non-transitory machine-readable storage media of claim 15, wherein the second cookie is configured to expire after a period of time following storage on the second computing device;
wherein, following expiration of the second cookie, the operations comprise:
receiving data from a third computing device indicating that a visitor to a Web page is interested in the good or service; and
storing the first cookie on the second computing device.

17. The one or more non-transitory machine-readable storage media of claim 15, wherein the operations comprise:
assigning the visitor to a second audience segment, wherein computing devices associated with members of the second audience segment store a third cookie, the third cookie comprising data indicating an interest that has a relationship to the good or service but that is not an interest in purchasing the good or service; and
storing the third cookie on the second computing device.

18. The one or more non-transitory machine-readable storage media of claim 17, wherein the third cookie is configured to expire after a period of time following storage on the second computing device;
wherein, following expiration of the third cookie, the operations comprise:
receiving data from a third computing device indicating that a visitor to a Web page is interested in the good or service; and
outputting the first cookie for storage on the second computing device.

19. The one or more non-transitory machine-readable storage media of claim 15, wherein the first computing device hosts the Web page or at least part of a Web site containing the Web page; and
wherein the one or more processing devices, the first computing device, and the second computing device are at different geographic locations.

20. The one or more non-transitory machine-readable storage media of claim 15, wherein the operations comprise:
assigning the visitor to additional audience segments, wherein computing devices associated with members of the additional audience segments store additional cookies, the additional cookies comprising data indicating interests that have a relationship to the good or service but that is not an interest in purchasing the good or service; and
storing the additional cookies on the second computing device.
